(19) United States
(12) Patent Application Publication
(10) Pub. No.: US 2010/0050627 A1
(43) Pub. Date: Mar. 4, 2010

(54) Hydraulic circuit with variable displacement flow divider

(76) Inventors: Bryan Edward Nelson, Lacon, IL (US); Kirat Shah, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/230,528

(22) Filed: Aug. 29, 2008

(51) Int. Cl. F15B 13/02

(52) U.S. Cl. 60/489

(57) ABSTRACT

A hydraulic circuit associated with a hydraulic actuator is provided having a reservoir situated to hold a supply of fluid and a pump situated to supply pressurized fluid to the hydraulic actuator. The hydraulic circuit also has a pressure intensifying valve fluidly connected to the reservoir and the hydraulic actuator. The pressure intensifying valve is situated to direct fluid to the reservoir while in a first position and direct fluid to the hydraulic actuator while in a second position. The hydraulic circuit further has a flow divider including a housing with an inlet fluidly connected to the pump, a first outlet fluidly connected to the hydraulic actuator, and a second outlet fluidly connected to the pressure intensifying valve. The flow divider also includes a first fluid transporting portion fluidly connected to the inlet and the first outlet and a second fluid transporting portion fluidly connected to the inlet and the second outlet. The flow divider further includes a first variable displacement actuator associated with the first fluid transporting portion. The first variable displacement actuator is situated to regulate a volume change associated with the first fluid transporting portion.

### TECHNICAL FIELD

The present disclosure is directed to a hydraulic circuit and, more particularly, to a hydraulic circuit with a variable displacement flow divider.

### BACKGROUND

Machines such as, for example, wheel loaders, dozers, backhoes, dump trucks, and other heavy equipment often utilize a hydraulic system having one or more hydraulic cylinders to assist the performance of various tasks. Such hydraulic systems are typically pressurized by a single main drive pump. The amount of force generated by each cylinder is limited by the amount of hydraulic pressure in the system. Some applications may require a temporary boost of force generated by the cylinder. However, sizing the main drive pump to generate the necessary pressure in the system for such a boost may be inefficient and may increase cost because such a pressure would be needed only for a small percentage of the pump's duty cycle.

One method that has been used to provide the increased pressure without sacrificing system efficiency is the utilization of flow dividers as circuit intensifiers. Such flow dividers are typically mounted or integrated with a cylinder and include a hydraulic pump and a hydraulic motor connected by a rotating shaft. Fluid flows into the flow divider and is directed through both the motor and the pump. Fluid exiting the pump is directed to the cylinder, while fluid exiting the motor is directed to a tank. Directing the fluid to a tank causes the motor to rotate the shaft, thereby driving the pump. As the pump is driven, the pressure of the fluid flowing to the cylinder is increased.

One example of a flow divider used as a circuit intensifier can be found in U.S. Pat. No. 7,000,386 (the '386 patent) issued to Morgan on Feb. 21, 2006. As disclosed in the '386 patent, a rotary flow divider includes a fixed displacement hydraulic pump and a fixed displacement hydraulic motor. When fluid pressure directed to the cylinder needs to be increased above the system pressure, the fluid flowing through the hydraulic motor is directed to a tank. Directing the fluid to the tank causes the hydraulic motor to generate a torque, which is used to drive the hydraulic pump. As the pump is driven, pressure flowing to the cylinder is increased.

Although the rotary flow divider of the '386 patent may provide a temporary boost in pressure, its application may be limited. In particular, the hydraulic motor and the hydraulic pump used in the system have fixed displacements. Therefore, the magnitude of the boost pressure generated by the flow divider is fixed. If the boost in pressure needed by the hydraulic cylinder varies, additional hydraulic equipment is needed to adjust the pressure.

Additionally, the configuration of the flow divider of the '386 patent may not be efficient. In particular, the flow divider uses a separate hydraulic motor and a separate hydraulic pump, which do not share components. However, at least some of the components used in the hydraulic motor are identical to the components used in the hydraulic pump. Therefore, duplicate parts must be manufactured in order for the flow divider to appropriately function. Duplicate parts increase the amount of material needed to build the system, which increases manufacturing costs.

The disclosed system is directed to overcoming one or more of the problems set forth above.

### SUMMARY

In one aspect, the present disclosure is directed toward a hydraulic circuit associated with a hydraulic actuator. The hydraulic circuit includes a reservoir situated to hold a supply of fluid and a pump situated to supply pressurized fluid to the hydraulic actuator. The hydraulic circuit also includes a pressure intensifying valve fluidly connected to the reservoir and the hydraulic actuator. The pressure intensifying valve is situated to direct fluid to the reservoir while in a first position and direct fluid to the hydraulic actuator while in a second position. The hydraulic circuit further includes a flow divider having a housing with an inlet fluidly connected to the pump, a first outlet fluidly connected to the hydraulic actuator, and a second outlet fluidly connected to the pressure intensifying valve. The flow divider also has a first fluid transporting portion fluidly connected to the inlet and the first outlet, and a second fluid transporting portion fluidly connected to the inlet and the second outlet. The flow divider further has a first variable displacement actuator associated with the first fluid transporting portion. The first variable displacement actuator is situated to regulate a volume change associated with the first fluid transporting portion.

In another aspect, the present disclosure is directed toward a hydraulic circuit associated with a hydraulic actuator. The hydraulic circuit includes a reservoir situated to hold a supply of fluid and a pump situated to supply pressurized fluid to the hydraulic actuator. The hydraulic circuit also includes a pressure intensifying valve fluidly connected to the reservoir and the hydraulic actuator. The pressure intensifying valve is situated to direct fluid to the reservoir while in a first position and direct fluid to the hydraulic actuator while in a second position. The hydraulic circuit further includes a flow divider having a housing with an inlet fluidly connected to the pump, a first outlet fluidly connected to the hydraulic actuator, and a second outlet fluidly connected to the pressure intensifying valve. The flow divider also has a central member rotatably situated within the housing. A first plurality of piston members are fixedly attached to the central member and situated to direct fluid from the inlet to the first outlet, and a second plurality of piston members are fixedly attached to the central member and situated to direct fluid from the inlet to the second outlet.

Consistent with yet another aspect of the disclosure, a method is provided for regulating the pressure of fluid being supplied to a hydraulic actuator. The method includes pressurizing a fluid and dividing the pressurized fluid into a first pressurized stream and a second pressurized stream. The method also includes directing the first pressurized stream through a first portion of a flow divider and directing the second pressurized stream through a second portion of the flow divider. Additionally, the method includes recombining the first and second pressurized streams when operating in a first operating mode. The method further includes directing the first pressurized stream to the hydraulic actuator, directing the second pressurized stream to a reservoir, and adjusting a volume change of the first pressurized stream to regulate the pressure of the first pressurized stream when operating in a second operating mode.

### BRIEF DESCRIPTION OF THE DRAWINGS

FIG. 1 is a diagrammatic illustration of an exemplary disclosed machine;

FIG. 2 is a schematic illustration of an exemplary intensifier portion of a hydraulic circuit for use with the machine of FIG. 1;

FIG. 3 is an exploded view illustration of the flow divider of FIG. 2;

FIG. 4 is a schematic illustration of another exemplary intensifier portion of a hydraulic circuit for use with the machine of FIG. 1; and

FIG. 5 is a flow chart illustrating an exemplary method for increasing pressure of the exemplary hydraulic circuits of FIG. 1.

### DETAILED DESCRIPTION

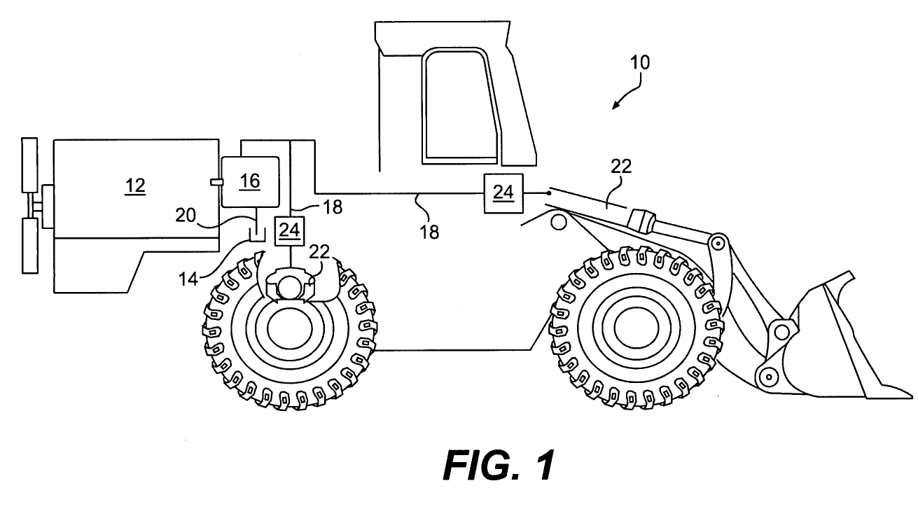

FIG. 1 illustrates an exemplary machine 10. Machine 10 may be stationary or mobile and may perform some type of operation associated with an industry such as mining, construction, farming, transportation, power generation, or any other industry known in the art. For example, machine 10 may embody a wheel loader configured to move earth at a construction site, a passenger vehicle configured to transport people or goods, a generator set configured to produce electrical power, or any other type of machine known in the art. Machine 10 may include, among other things, a power source 12, a tank 14, a main drive pump 16, and one or more hydraulic circuits 18.

Power source 12 may embody an engine such as, for example, a diesel engine, a gasoline engine, a gaseous fuel-powered engine such as a natural gas engine, or any other type of combustion engine apparent to one skilled in the art. Power source 12 may alternatively embody a non-combustion source of power such as a fuel cell, a power storage device, or any other suitable source of power. Power source 12 may produce a mechanical or electrical power output that drives main drive pump 16 to pressurize fluid.

Tank 14 may constitute a reservoir configured to hold a supply of low pressure fluid. The fluid may include, for example, a dedicated hydraulic oil, an engine lubrication oil, a transmission lubrication oil, an engine fuel, or any other fluid known in the art. One or more hydraulic systems within machine 10 may draw fluid from and return fluid to tank 14. It is also contemplated that machine 10 may alternatively be connected to multiple separate fluid tanks.

Main drive pump 16 may draw fluid from tank 14 via a suction line 20 and may produce a flow of fluid for pressurizing hydraulic circuits 18. Main drive pump 16 may embody a variable displacement pump such as a swash plate-piston type pump or another type of pump configured to produce a variable flow of pressurized fluid. Furthermore, main drive pump 16 may be drivably connected to power source 12 by, for example, a countershaft (not shown), a belt (not shown), an electrical circuit (not shown), or in any other suitable manner such that an output rotation of power source 12 results in a pumping action of main drive pump 16.

Hydraulic circuits 18 may receive pressurized fluid from main drive pump 16 and direct the pressurized fluid to one or more hydraulic actuators 22. Such hydraulic actuators may include, for example, a brake mechanism, a fluid cylinder, a steering mechanism, a cooling component, a pilot operated control device, a drive motor, a swing motor, and other devices known in the art. In addition, each hydraulic circuit 18 may include an intensifier portion 24 for boosting the pressure of fluid being directed to hydraulic actuators 22 to a level above the pressure generated by main drive pump 16.

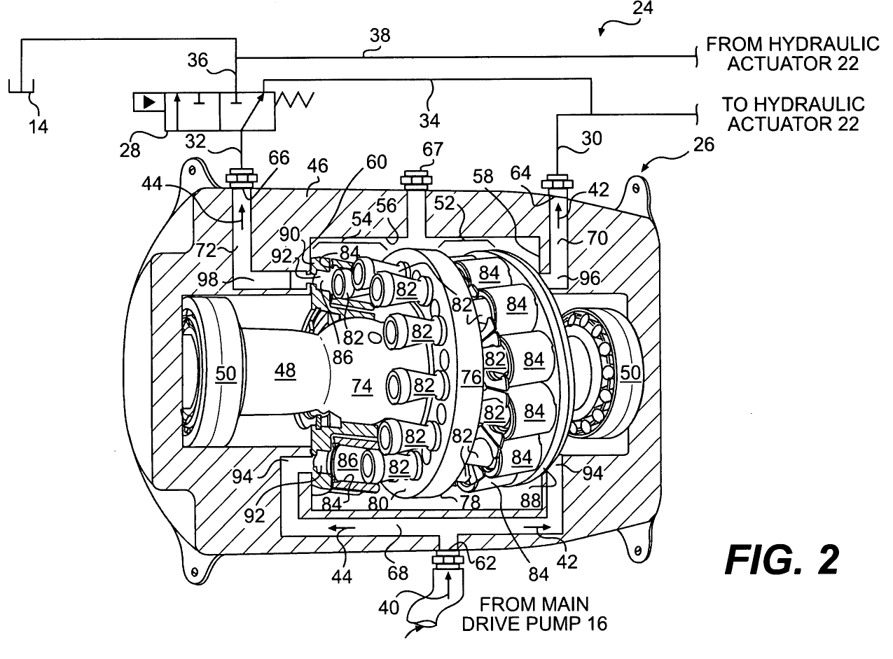

FIG. 2 illustrates an exemplary intensifier portion 24 of each hydraulic circuit 18. Intensifier portion 24 may be located proximate an associated hydraulic actuator 22 and may increase the pressure of fluid being directed to the associated hydraulic actuator 22 to a level above the pressure generated by main drive pump 16. In addition, intensifier portion 24 may include a flow divider 26 and an intensifier switch valve 28 for controlling when the fluid pressure may be increased above the level of pressure generated by main drive pump 16. A fluid passage 30 may fluidly connect flow divider 26 to the associated hydraulic actuator 22. In addition, intensifier switch valve 28 may be fluidly connected to flow divider 26, the associated hydraulic actuator 22, and tank 14 via fluid passages 32, 34, and 36, respectively. Furthermore, the associated hydraulic actuator 22 may be fluidly connected to tank 14 via a fluid passage 38. It is contemplated that intensifier portion 24 may include additional or different components, such as, for example, accumulators, check valves, pressure relief or makeup valves, pressure compensating elements, restrictive orifices, and other hydraulic components known in the art.

Flow divider 26 may be an assembly of multiple components that interact to divide a single fluid stream 40 into divided fluid streams 42 and 44 and increase the pressure of fluid being directed to the associated hydraulic actuator 22. In particular, flow divider 26 may include a housing 46, a central member 48 supported within housing 46 by way of bearings 50, a first fluid transporting portion 52, and a second fluid transporting portion 54. Both first and second fluid transporting portions 52, 54 may be supported by central member 48.

Housing 46 may include a central bore 56 having a first axial end 58 and a second axial end 60. Housing 46 may also include an inlet port 62 in fluid communication with main drive pump 16, a first outlet port 64 in fluid communication with the associated hydraulic actuator 22, a second outlet port 66 in fluid communication with intensifier switch valve 28, and a case drain 67. An internal fluid passageway 68 may direct fluid streams 42 and 44 from inlet port 62 to first fluid transporting portion 52 and second fluid transporting portion 54, respectively. In addition, an internal fluid passageway 70 may direct fluid stream 42 from first fluid transporting portion 52 to first outlet port 64. Furthermore, an internal fluid passageway 72 may direct fluid stream 44 from second fluid transporting portion 54 to second outlet port 66.

Central member 48 may support various components of first and second fluid transporting portions 52, 54 and may include a shaft 74 and a rotor 76. Shaft 74 may extend to bearings 50 and may be substantially axially aligned with central bore 56. Bearings 50 may engage interior walls of central bore 56 to support the rotation of shaft 74 therein. Rotor 76 may embody a plate-like member fixedly connected to shaft 74 such that a rotation of shaft 74 may result in a direct rotation of rotor 76. Rotor 76 may be integral to shaft 74 or, alternatively, joined to shaft 74 through a welding, sintering, or other known metal joining process. Rotor 76 may include opposing faces 78, 80 oriented substantially orthogonal to the axial direction of shaft 74.

First fluid transporting portion 52 may include numerous components that interact to direct fluid from inlet 62 to first outlet 64. In addition, second fluid transporting portion 54 may include numerous components that interact to direct fluid from inlet 62 to second outlet 66. For example, each of first and second fluid transporting portions 52, 54 may include a plurality of cup-like piston members 82 fixedly connected to opposing faces 78 and 80 of rotor 76 and a plurality of drum sleeves 84. Each piston member 82 may engage a corresponding drum sleeve 84 to form a chamber 86.

Each of drum sleeves 84 associated with those piston members 82 extending from face 78 may be connected to an inclined drum plate 88, while each of drum sleeves 84 associated with those piston members 82 extending from face 80 may be connected to a similar opposing inclined drum plate 90. Drum plates 88 and 90 may be connected to rotate with central member 48 and may direct fluid into and out of chambers 86. As central member 48 and drum plates 88, 90 rotate, piston members 82 may move into and out of drum sleeves 84, thereby changing the volume of chambers 86. As the volume of chambers 86 increases, fluid from internal fluid passageway 68 may flow into chambers 86 through a plurality of distribution holes 92 in drum plates 88 and 90. As the volume of chambers 86 decreases, fluid from chambers 86 may be forced back through distribution holes 92 to internal fluid passageways 70 and 72.

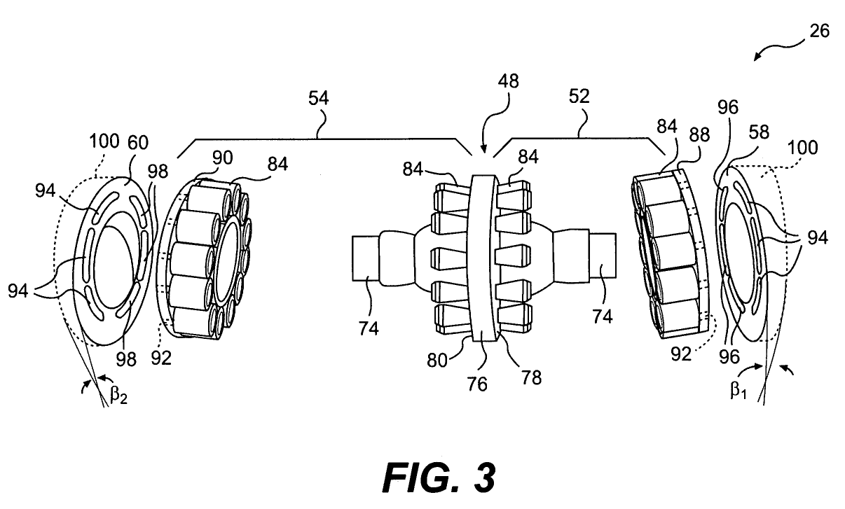

At each of first and second axial ends 58, 60 of housing 46, internal fluid passageway 68 may be in fluid communication with only half of distribution holes 92 at one time via a plurality of distribution passageways 94, while internal fluid passageways 70, 72 may be in communication with the remaining distribution holes 92 via distribution passageways 96 and 98, respectively. Although illustrated in FIG. 2 as being located within first and second axial ends 58, 60 of housing 46, FIG. 3 illustrates that distribution passageways 94, 96, and 98, may alternatively be located within a swash plate 100 located at each of first and second axial ends 58, 60 of housing 46.

Drum plates 88, 90 may be inclined to an angle β defined by the geometry of first and second axial ends 58, 60 (or swash plates 100, if implemented). In particular, first and second axial ends 58, 60 (and swash plates 100) may be fixed during manufacture at a particular tilt angle β relative to the axial direction of shaft 74. Because of the assembled relationship between first and second axial ends 58, 60 and drum plates 88, 90, this tilt angle β may correspond to the volume change of chambers 86 during a revolution of shaft 74. In fact, the tilt angle β₁ associated with first fluid transporting portion 52 may be different from the tilt angle β₂ associate with second fluid transporting portion 54. In this manner, the volume change of chambers 86 associated with first fluid transporting portion 52 during a single revolution of rotor 76 may be different from the volume change of chambers 86 associated with second fluid transporting portion 54 during the same revolution of rotor 76.

Referring back to FIG. 2, intensifier switch valve 28 may be operable to control the flow of fluid stream 44. Although illustrated as a solenoid operated valve, it is contemplated that the operation of intensifier switch valve 28 may be controlled pneumatically or hydraulically, if desired. In addition, intensifier switch valve 28 may be set to either a base-line pressure position (the position illustrated in FIG. 2) or a intensified pressure position. It is further contemplated that intensifier switch valve 28 may be a proportional valve, if desired.

When set to the base-line pressure position, fluid stream 44 may be directed through fluid passage 34 and recombined with fluid stream 42 in fluid passage 30 upstream of hydraulic actuator 22. At the same time, the fluid pressure of fluid stream 40 may cause first and second fluid transporting portions 52, 54 to rotate. This rotational motion may direct fluid streams 42 and 44 through first and second outlet ports 64, 66, respectively. In other words, the pressurized fluid entering inlet port 62 may drive both first and second fluid transporting portions 52, 54, thereby causing both first and second fluid transporting portions 52, 54 to act as hydraulic motors. In addition, recombining fluid streams 42 and 44 upstream of hydraulic actuator 22 may cause first and second outlet ports 64, 66 to act as a single outlet port. Therefore, each of fluid streams 42, 44 may have substantially the same pressure change as the respective stream flows through first and second fluid transporting portions 52, 54. With substantially the same pressure change, the pressure of fluid streams 42 and 44 may be substantially the same regardless of any difference between tilt angle β₁ and tilt angle β₂. As a result, the pressure of fluid entering flow divider 26 when intensifier switch valve 28 is set to the base-line pressure position may be substantially the same as the pressure of fluid entering hydraulic actuator 22.

When intensifier switch valve 28 is set to the intensified pressure position, fluid stream 44 may be directed to tank 14 while fluid stream 42 may be directed to hydraulic actuator 22. Because tank 14 may hold low pressure fluid and hydraulic actuator 22 may hold pressurized fluid, the pressure change across first fluid transporting portion 52 may be substantially less than the pressure change across second fluid transporting portion 54. Due to this imbalance, more force may be needed to drive first fluid transporting portion 52 than the amount of force needed to drive second fluid transporting portion 54. The excess energy in fluid stream 44 may increase the rotational speed of second fluid transporting portion 54 and ultimately, the rotational speed of central member 48. In addition, because the components of first fluid transporting portion 52 may be attached to central member 48, the rotational speed of first fluid transporting portion 52 may also be increased. In other words, when directing fluid stream 44 to tank 14, second fluid transporting portion 54 may act as a hydraulic motor powered by the pressure of fluid stream 40 and may drive first fluid transporting portion 52. While being driven by second fluid transporting portion 54, first fluid transporting portion 52 may act as a pump, which may increase the pressure of fluid stream 42.

The magnitudes of tilt angle β₁ and tilt angle β₂ may also contribute to the difference between the pressure changes across first and second fluid transporting portions 52, 54 because each tilt angle may affect the volume change of associated chambers 86 as first and second fluid transporting portions 52 and 54 rotate. The magnitude of each volume change may correspond to a particular magnitude of pressure change across the corresponding fluid transporting portion. Therefore, the adjustment of tilt angle β₁ and/or tilt angle β₂ may further manipulate the pressure of fluid stream 42.

In an exemplary embodiment, tilt angle β₁ and tilt angle β₂ may be substantially the same, and the pressure change across first and second fluid transporting portions 52, 54 caused by their respective volume changes may be substantially the same. Therefore, the only factor contributing to the pressure change imbalance encountered by flow divider 26 may be the pressure difference between fluid stream 40 and the pressure of fluid in tank 14. This pressure difference may be approximately twice the pressure differential between fluid stream 40 and fluid stream 42. As a result, the pressure of fluid stream 42 may be increased to approximately twice the pressure of fluid stream 40.

However, if tilt angle β₁ is greater than tilt angle β₂, the pressure change caused by the volume change associated with first fluid transporting portion 52 may be greater than the pressure change caused by the volume change associated with second fluid transporting portion 54. Such a differential may at least partially counter the pressure change imbalance between first and second fluid transporting portions 52, 54 caused by the pressure differential between fluid stream 40 and the pressure of fluid in tank 14. Therefore, if tilt angle β₁ is greater than tilt angle β₂, the increase in the pressure of fluid stream 42 may be less than twice the pressure of fluid stream 40. Conversely, if tilt angle β₁ is less than tilt angle β₂, the pressure change caused by the volume change associated with first fluid transporting portion 52 may be less than the pressure change caused by the volume change associated with second fluid transporting portion 54. Such a differential may contribute to the pressure change imbalance between first and second fluid transporting portions 52, 54 caused by the pressure differential between fluid stream 40 and the pressure of fluid in tank 14. Therefore, if tilt angle β₁ is less than tilt angle β₂, the increase in the pressure of fluid stream 42 may be greater than twice the pressure of fluid stream 40.

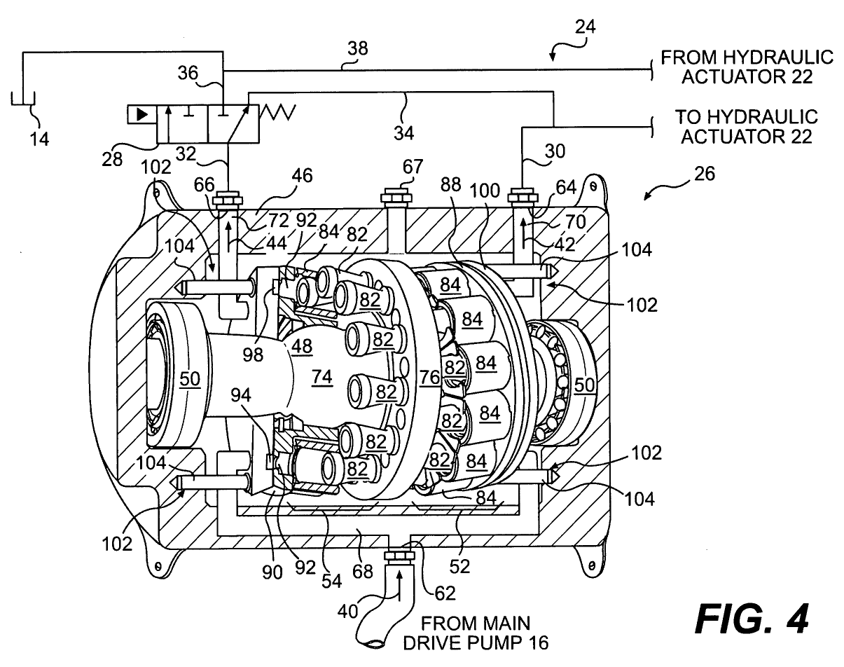

In the exemplary embodiment illustrated in FIG. 2, tilt angle β₁ and tilt angle β₂ may be fixed. Therefore, the magnitude of boost pressure available from intensifier portion 24 may be a fixed value. FIG. 4 illustrates an alternative embodiment of flow divider 26, which may permit a variable boost in pressure. Similar to flow divider 26 of FIGS. 2 and 3, flow divider 26 of FIG. 4 may include housing 46, central member 48, first fluid transporting portion 52, and second fluid transporting portion 54. However, in contrast to flow divider 26 of FIGS. 2 and 3, first fluid transporting portion 52 and/or second fluid transporting portion 54 of FIG. 4 may produce streams of pressurized fluid having variable flow characteristics. In particular, flow divider 26 of FIG. 4 may include a variable displacement actuator 102 located at first axial end 58 and/or second axial end 60 of housing 46.

Variable displacement actuator 102 may include components that adjust the tilt angle β of swash plate 100 and subsequently the volume change of chambers 86. Specifically, variable displacement actuator 102 may include one or more control pistons 104 that may directly or indirectly press against a portion of swash plate 100 to urge swash plate 100 to tilt relative to the axial direction of shaft 74. Control pistons 104 may be hydraulically actuated, pneumatically actuated, electrically actuated, or actuated in any other known manner such that swash plate 100 may be tilted to a specific desired tilt angle corresponding to a desired characteristic (e.g. flow rate and/or pressure) of the resulting stream of pressurized fluid. The control pistons 104 associated with swash plate 100 at first axial end 58 may be operated independent of the control pistons 104 at the opposing second axial end 60 such that tilt angle β₁ may be varied simultaneous to and independent of tilt angle β₂.

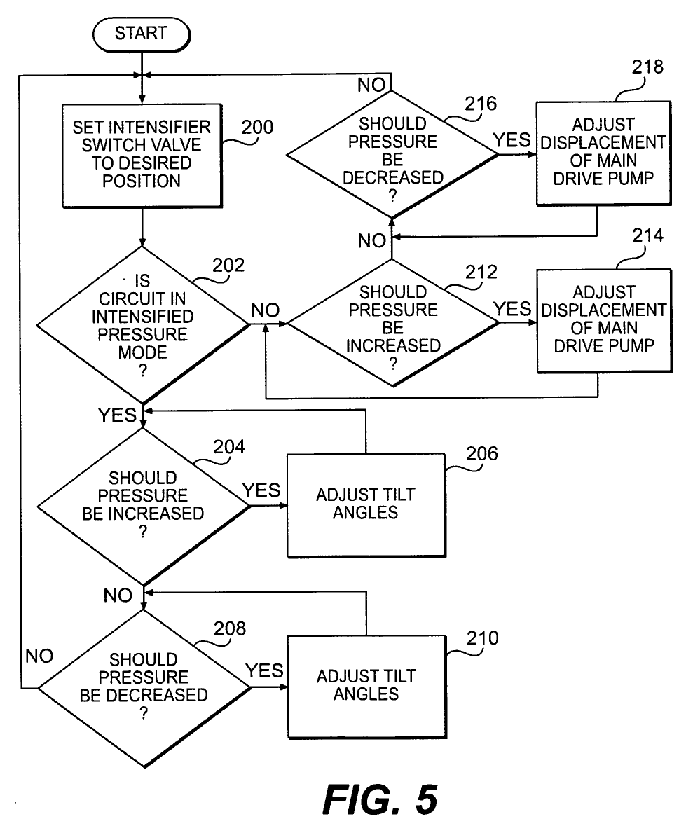

FIG. 5, which is discussed in the following section, illustrates the operation of intensifier portion 24. In particular, FIG. 5 illustrates an exemplary method for increasing or decreasing the pressure of fluid being directed to an associated hydraulic actuator 22.

### INDUSTRIAL APPLICABILITY

The disclosed hydraulic intensifier circuit may improve efficiency and increase the versatility of the associated hydraulic circuit. In particular, the hydraulic intensifier circuit may include a flow divider having a hydraulic motor portion and a hydraulic motor/pump portion that may share central core components. In addition, the displacements of fluid associated with the hydraulic motor and hydraulic motor/pump portions may be variable. This may permit the hydraulic intensifier circuit to generate a variety of boost pressures that may be needed by an associated hydraulic actuator, while minimizing the number of components utilized. Operation of the intensifier circuit will now be described.

FIG. 5 illustrates a flow diagram depicting an exemplary method for operating intensifier portion 24 of an exemplary hydraulic circuit 18. The method may begin when intensifier switch valve 28 may be set to a desired position (step 200). It is contemplated that intensifier switch valve 28 may be set to the desired position either automatically by a control system or manually by input from an operator. In addition, the desired position may be determined in any number of ways. For example, a control system may determine a pressure magnitude needed by an associated hydraulic actuator 22 from signals received from various sensors. Alternatively, an operator may set intensifier switch valve 28 to a desired position based on an application being performed by machine 10.

After intensifier switch valve 28 has been set to the desired position, the mode in which intensifier portion 24 is operating may be determined (i.e., whether or not intensifier portion 24 is operating in the intensified pressure mode) (step 202). Intensifier portion 24 may be operating in the intensified pressure mode if intensifier switch valve 28 is set to the intensified pressure position. Conversely, intensifier portion 24 may be operating in the base-line pressure mode if intensifier switch valve 28 is set to the base-line pressure position. If intensifier portion 24 is operating in the intensified pressure mode (step 202: Yes), it may be determined whether the pressure of the fluid being directed to the associated hydraulic actuator 22 should be increased (step 204). The pressure may be increased in response to any number of factors. For example, the pressure should be increased if machine 10 is not performing a particular task adequately at the current pressure. Alternatively, the pressure may be increased if a control system (not shown) determines that a particular machine operation may require a fluid pressure greater than the pressure of fluid being directed to the associated hydraulic actuator 22.

If it is determined that the fluid pressure should be increased (step 204: Yes), the tilt angles associated with first fluid transporting portion 52 and/or second fluid transporting portion 54 may be adjusted (step 206). This adjustment may be performed by adjusting the length of control pistons 104 associated with first fluid transporting portion 52 and/or second fluid transporting portion 54. By adjusting the tilt angles, the relative volume changes associated with fluid first and second fluid transporting portions 52, 54 may be adjusted. Adjusting the relative volume changes may affect the relative pressure changes across first and second fluid transporting portions 52, 54, which may ultimately affect the magnitude of the pressure generated by first fluid transporting portion 52. For example, increasing the volume change associated with first fluid transporting portion 52 may decrease the pressure of fluid stream 42, while decreasing the volume change associated with first fluid transporting portion 52 may increase the pressure of fluid stream 42. Conversely, increasing the volume change associate with second fluid transporting portion 54 may increase the pressure of fluid stream 42, while decreasing the volume change associated with second fluid transporting portion 54 may decrease the pressure of fluid stream 42. After the tilt angles have been adjusted (step 206), step 204 may be repeated (i.e., it may be determined whether the pressure of the fluid being directed to the associated hydraulic actuator 22 should be increased).

If it is determined that the fluid pressure should not be increased (step 204: No), it may be determined whether the pressure of the fluid being directed to the associated hydraulic actuator 22 should be decreased (step 208). The pressure may be decreased in response to various factors. For example, the pressure may be decreased if machine 10 is not performing a particular task adequately at the current pressure. Alternatively, the pressure may be decreased if a control system (not shown) determines that a particular machine operation may require a fluid pressure less than the pressure of fluid being directed to the associated hydraulic actuator 22. If it is determined that the fluid pressure should not be decreased (step 208: No), step 200 may be repeated (i.e., intensifier switch valve 28 may be set to a desired position). However, if it is determined that the pressure may be decreased (step 208: Yes), the tilt angles associated with second fluid transporting portion 54 and/or first fluid transporting portion 52 may be adjusted accordingly (step 210). The adjustment of the tilt angles may be may in a manner similar to that disclosed above in step 206. After the tilt angles have been adjusted, step 208 may be repeated (i.e., it may be determined whether the pressure of the fluid being directed to the associated hydraulic actuator 22 should be decreased).

Referring back to step 202, if intensifier portion 24 is operating in the base-line pressure mode (step 202: No), it may be determined whether the pressure of the fluid being directed to the associated hydraulic actuator 22 should be increased (step 212). The determination may be made in a manner similar to that disclosed above for step 204. If it is determined that the pressure may be increased (step 212: Yes), the displacement of main drive pump 16 may be adjusted accordingly (step 214). After adjusting the displacement of main drive pump 16, step 212 may be repeated (i.e., it may be determined whether the pressure of the fluid being directed to the associated hydraulic actuator 22 should be increased). However, if it is determined that the pressure should not be increased (step 212: No), it may be determined whether the pressure of the fluid being directed to the associated hydraulic actuator 22 should be decreased (step 216). If it is determined that the pressure should not be decreased (step 216: No), step 200 may be repeated (i.e., intensifier switch valve 28 may be set to a desired position). However, if it is determined that the pressure may be decreased (step 216: Yes), the displacement of main drive pump 16 may be adjusted accordingly (step 218). After adjusting the displacement of main drive pump 16, step 216 may be repeated (i.e., it is determined whether the pressure of the fluid being directed to the associated hydraulic actuator 22 should be decreased).

Varying the volume change associated with the pump portion and/or the motor portion of the flow divider may increase the flexibility of the intensifier circuit. In particular, the variety of pressure magnitudes available for a particular hydraulic actuator may be increased. This may permit the utilization of a single device to boost circuit pressure for each hydraulic actuator, thereby reducing manufacturing costs and complexities.

Manufacturing costs may also be reduced because the motor and pump portions of the flow divider may share various components. For example, the motor and pump portions may share a central body member, which may include a shaft and a rotor. By reducing the number of flow divider components, manufacturing costs may be reduced.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A hydraulic circuit associated with a hydraulic actuator, comprising:
a reservoir situated to hold a supply of fluid;
a pump situated to supply pressurized fluid to the hydraulic actuator;
a pressure intensifying valve fluidly connected to the reservoir and the hydraulic actuator and situated to direct fluid to the reservoir while in a first position and direct fluid to the hydraulic actuator while in a second position; and
a flow divider, including:
a housing having:
an inlet fluidly connected to the pump;
a first outlet fluidly connected to the hydraulic actuator; and
a second outlet fluidly connected to the pressure intensifying valve;
a first fluid transporting portion fluidly connected to the inlet and the first outlet;
a second fluid transporting portion fluidly connected to the inlet and the second outlet; and
a first variable displacement actuator associated with the first fluid transporting portion and situated to regulate a volume change associated with the first fluid transporting portion.

2. The hydraulic circuit of claim 1, wherein the flow divider further includes a second variable displacement actuator associated with the second fluid transporting portion and situated to regulate a volume change associated with the second fluid transporting portion.

3. The hydraulic circuit of claim 2, wherein the flow divider further includes a central member rotatably situated within the housing.

4. The hydraulic circuit of claim 3, wherein the flow divider further includes a first plurality of piston members fixedly attached to the central member and situated to direct fluid from the inlet to the first outlet and a second plurality of piston members fixedly attached to the central member and situated to direct fluid from the inlet to the second outlet.

5. The hydraulic circuit of claim 4, wherein the flow divider further includes a first plurality of cylinders fixedly attached to a first drum plate and positioned to slidingly receive the first plurality of piston members and a second plurality of cylinders fixedly attached to a second drum plate and positioned to slidingly receive the second plurality of piston members.

6. The hydraulic circuit of claim 5, wherein the first drum plate is tilted at a first angle relative to a symmetrical longitudinal axis of the shaft and the second drum plate is tilted at a second angle relative to a symmetrical longitudinal axis of the shaft.

7. The hydraulic circuit of claim 6, wherein the first variable displacement actuator is situated to adjust the tilt angle of the first drum plate, and the second variable displacement actuator is situated to adjust the tilt angle of the second drum plate.

8. A hydraulic circuit associated with a hydraulic actuator, comprising:
a reservoir situated to hold a supply of fluid;
a pump situated to supply pressurized fluid to the hydraulic actuator;
a pressure intensifying valve fluidly connected to the reservoir and the hydraulic actuator and situated to direct fluid to the reservoir while in a first position and direct fluid to the hydraulic actuator while in a second position; and
a flow divider, including:
a housing having:
an inlet fluidly connected to the pump;
a first outlet fluidly connected to the hydraulic actuator; and
a second outlet fluidly connected to the pressure intensifying valve;
a central member rotatably situated within the housing;
a first plurality of piston members fixedly attached to the central member and situated to direct fluid from the inlet to the first outlet; and
a second plurality of piston members fixedly attached to the central member and situated to direct fluid from the inlet to the second outlet.

9. The hydraulic circuit of claim 8, wherein the central member includes a shaft rotatably connected to the housing and a rotor fixedly attached to the shaft.

10. The hydraulic circuit of claim 8, wherein the flow divider further includes a first plurality of cylinders fixedly attached to a first drum plate and positioned to slidingly receive the first plurality of piston members and a second plurality of cylinders fixedly attached to a second drum plate and positioned to slidingly receive the second plurality of piston members.

11. The hydraulic circuit of claim 10, wherein the first and second drum plates are fixedly attached to the shaft so that each drum plate rotates at substantially the same rate as the shaft.

12. The hydraulic circuit of claim 11, wherein the first drum plate is tilted at a first angle relative to a symmetrical longitudinal axis of the shaft.

13. The hydraulic circuit of claim 12, wherein the second drum plate is tilted at a second angle relative to a symmetrical longitudinal axis of the shaft.

14. A method for regulating the pressure of fluid being supplied to a hydraulic actuator, comprising:
pressurizing a fluid;
dividing the pressurized fluid into a first pressurized stream and a second pressurized stream;
directing the first pressurized stream through a first portion of a flow divider;
directing the second pressurized stream through a second portion of the flow divider;
recombining the first and second pressurized streams when operating in a first operating mode; and
directing the first pressurized stream to the hydraulic actuator, directing the second pressurized stream to a reservoir, and adjusting a volume change of the first pressurized stream to regulate the pressure of the first pressurized stream when operating in a second operating mode.

15. The method of claim 14, further including adjusting a volume change of the second pressurized stream to regulate the pressure of the first pressurized fluid stream when operating in the second operating mode.

16. The method of claim 15, wherein the first and second portions of the flow divider share a rotor.

17. The method of claim 16, further including increasing the pressure of the first pressurized stream by decreasing the volume change of the first fluid stream.

18. The method of claim 17, further including decreasing the pressure of the first pressurized stream by increasing the volume change of the first fluid stream.

19. The method of claim 18, further including increasing the pressure of the first pressurized stream by increasing the volume change of the second fluid stream.

20. The method of claim 19, further including decreasing the pressure of the first pressurized stream by decreasing the volume change of the second fluid stream.
